(19) United States
(12) Patent Application Publication
(10) Pub. No.: US 2009/0036806 A1
(43) Pub. Date: Feb. 5, 2009

(54) Inflatable apparatus for holding massage actuators

(75) Inventor: Simon Siu Man Nan, Ontario (CA)

Correspondence Address: GREENSFELDER HEMKER & GALE PC, SUITE 2000, 10 SOUTH BROADWAY, ST LOUIS, MO, 63102, US

(73) Assignee: Nanma Manufacturing Co., Ltd., Chai Wan (HK)

(21) Appl. No.: 11/888,473

(22) Filed: Aug. 1, 2007

(51) Int. Cl. A61H 19/00

(52) U.S. Cl. 601/49

(57) ABSTRACT

Massage apparatus of the invention includes a spherical inflatable body made of resilient material for mounting a massage actuator, the body having a socket mechanism accessible at its surface for holding the massage actuator, the body having an air-nozzle for inflation/deflation. The massage actuator is either of powered nature or non-powered nature. Various embodiments are disclosed.

### CROSS-REFERENCE TO RELATED APPLICATION(S)

(Not applicable.)

### BACKGROUND

The present invention relates generally to a sexual assistance apparatus such as hand-held vibrators and other massage actuators and more particularly to an inflatable apparatus for holding a massage actuator, whether of powered or non-powered nature, for sexual aid or vibration stimulation relative to the human body for therapeutic or stimulatory use.

Prior art sexual aid or stimulating devices having massage actuators are usually held by the hand of user or mounted on a structure providing support. There are a number of problems in the actuator holding methodology of existing designs.

If the actuator is intended for holding by hand, it is easy to cause the user become tired in applying the actuator.

On the other hand, if the actuator is mounted on a structural support, the user needs to fix the actuator and to carefully set up the actuator for getting a suitable relative position and/or orientation between the actuator and the user's body. This provides considerable inconvenience to the user. Further, when the actuator is mounted on a rigid support, during the application to the user, the body's movement relative to the support is very much limited if there is to be maintained a desirable relative position/orientation which has been preset.

The user also has to pay extra attention on controlling penetration depth of the actuator into an organ of the body to prevent the user from being hurt by the actuator by over-penetrating. This will at least downgrade the degree of sexual gratification and pleasure level.

Further, such prior art apparatuses have not provided an easy means for exchanging actuators connected to a support of the apparatus.

Moreover, such prior art apparatuses do not provide users with am inflatable comfortable support of an inflatable or cushioning nature for supporting the user's body during application.

The aforementioned shortcomings of the prior art apparatus are such that existing sexual aided massage apparatus can't meet all the objects and advantages and features stated herein.

The present invention was developed to provide a massage apparatus having a massage actuator flexibly elastically mounted on an inflatable structural body for providing advantages over known apparatuses.

Among the objects, features, advantages and benefits of the present invention are apparatus and methodology achieving the following:

Provision of a massage apparatus capable of providing sexual stimulation to the user in which the massage actuator is useable while held by the apparatus and without having to be held by hand.

Provision of a massage apparatus intended capable of providing sexual stimulation to the user by effectively holding and using various massage actuators of different shapes, dimensions, materials and operation functions.

Provision of a massage apparatus useful capable of providing sexual stimulation to the user in which the massage actuator such as an artificial penis which is flexibly elastically held by the apparatus.

Provision of a massage apparatus capable of providing sexual stimulation to the user in which the massage actuator such as an artificial penis where the apparatus allows various holding angles of the massage actuator without requiring any complicated holding mechanism.

Provision of a massage apparatus capable of providing sexual stimulation to the user in which the massage actuator such as an artificial penis where the apparatus prevents the user from being hurt by penetrating the artificial penis too deep into the human organ.

Provision of a massage apparatus capable of providing sexual stimulation to the user which provides a cushioning support to the user's body while applying the massage actuator.

Provision of a massage apparatus capable of providing sexual stimulation to the user which allows the massage actuator to be quickly attaching to and detached from a holding body of the apparatus.

Provision of a massage apparatus capable of providing sexual stimulation to the user that is easily portable and efficiently stored when it is not in use.

The present invention therefore seeks to provide for a massage apparatus comprising an inflatable ball detachably holding a massage actuator achieving the objects and features and advantages noted above. Preferred embodiments of the present invention are presented, by way of example only, with reference to the accompanying drawings.

Briefly, the massage apparatus of the invention generally comprises a spherical inflatable body made of resilient material having a socket mechanism for holding the massage actuator, as in a combination with a massage actuator. The body has an air-nozzle for inflation/deflation. The massage actuator can be either of powered nature (such as vibration or squirming) with a controller or non-powered nature (such as a phallic-simulative article). The massage actuator is detachably connected to the inflatable body. In application of the apparatus, a user may ride on or may otherwise engage the inflatable body with the massage actuator touching or inserted into an organ for massage.

### BRIEF DESCRIPTION OF THE DRAWINGS

FIG. 1 shows a perspective-type view of the present invention with an electrical powered massage actuator shown detached from the inflatable ball.

FIG. 2 shows a perspective-type view of the present invention shown in FIG. 1 with the massage actuator attached to the inflatable ball.

FIG. 3 shows a perspective-type view of the present invention with a non-powered massager shown detached from the inflatable ball.

FIG. 4 shows a perspective-type view of the present invention shown in FIG. 3 with the massager attached to the inflatable ball.

FIG. 5 shows an orthogonal section view of the present invention shown in FIG. 4 illustrating the air-nozzle mechanism.

FIG. 6 shows an orthogonal section view of an alternative embodiment of the present invention illustrating an actuator adapting mechanism.

FIG. 7 shows a perspective-type view of another alternative embodiment of the present invention illustrating a massager attaching mechanism.

Corresponding reference characters indicate corresponding parts in multiple figures of the drawings.

### Description of Various Embodiments

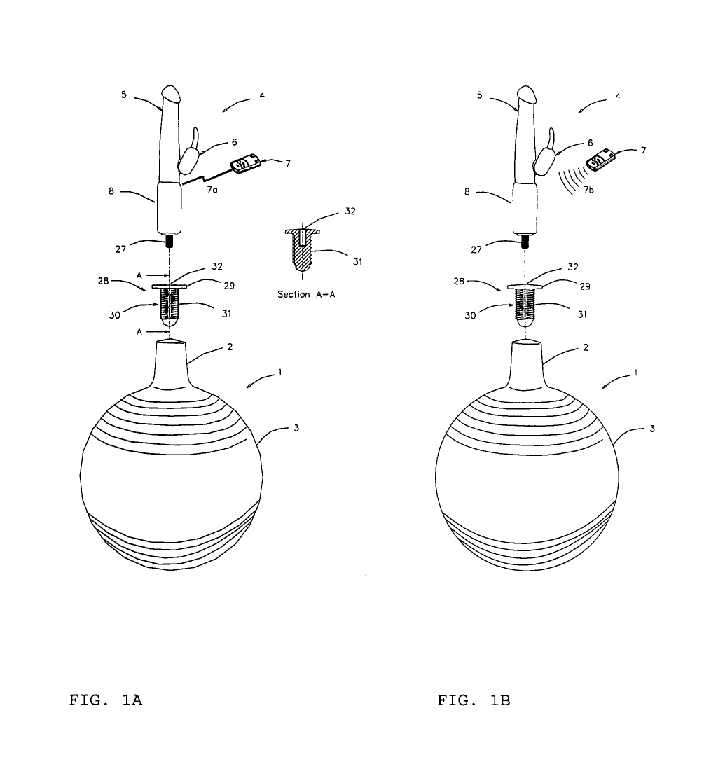

Referring to FIG. 1, in one embodiment of the present invention, inflatable apparatus 1 is formed of elastic resilient membrane comprising a hollow tubular neck (“tube”) 2 and ball 3, as here shown inflated, is provided for holding, as one embodiment, a powered-type massage actuator 4 comprising a squirming head 5, a vibration head 6, a controller 7 having a power cable 7a to control the heads, a hand-held portion 8 and an externally threaded fastening stud 27 disposed at the end of hand-held portion 8.

Whether massage actuator 4 is of powered type or non-powered type, according to an embodiment, it may be of a phallic-simulative character.

An adaptor 28 is provided for securement of the massage actuator. Adapter 28 comprises a flange 29, a cylinder 30 having a screw thread 31 and a screw thread hole 32. Adaptor 28 is connected to massage actuator 4 by threading fastening stud 27 onto the corresponding threaded hole 32.

The controller 7 can be operatively connected to the massage actuator 4 by cable 7a as shown in FIG. 1A for controlling operation. Alternatively, the controller 7 can also remotely control the massage actuator 4 by a wireless device means 7b as shown in FIG. 1B.

The wireless device of the controller can be of RF (radio frequency) signal type, IR (infrared) signal type or provide other wireless visible or invisible control signals.

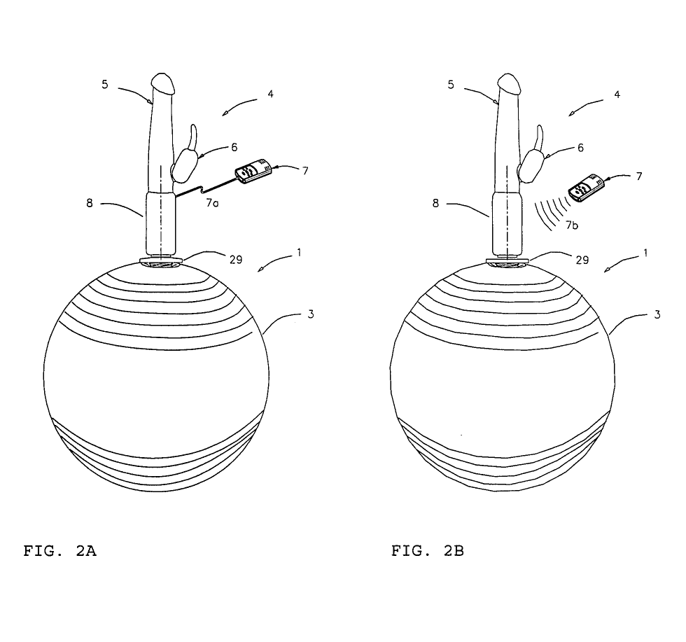

Referring to FIG. 2, tube 2 of the apparatus is inwardly reversed into ball 3 and so forming a cavity opening from the ball surface, and by rotating screw thread 31 of adaptor 28, carrying massage actuator 4, into the cavity, the massage actuator 4 is held in place at the surface of the ball 3 with the massage actuator exteriorly of the ball body and resiliently supported thereby for user access.

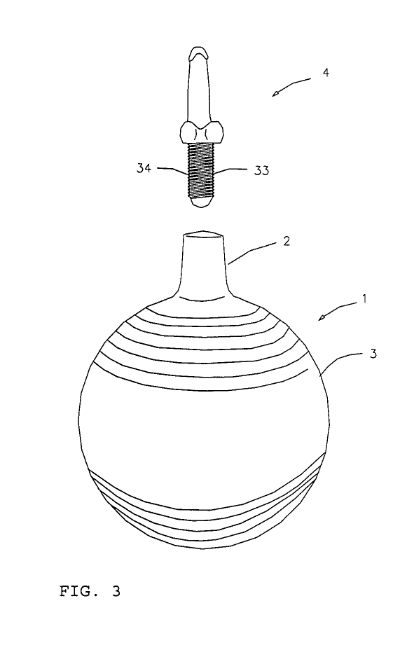

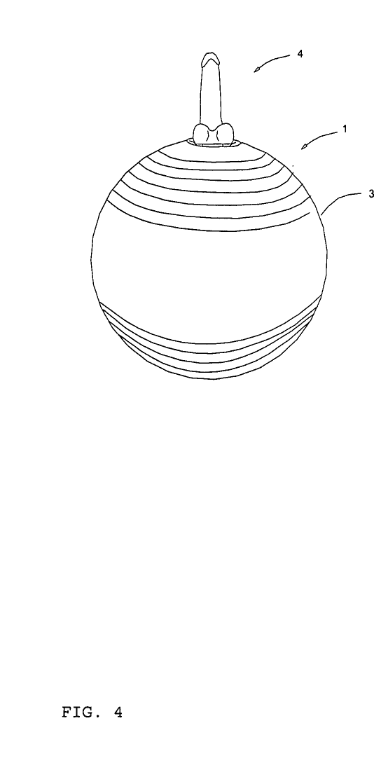

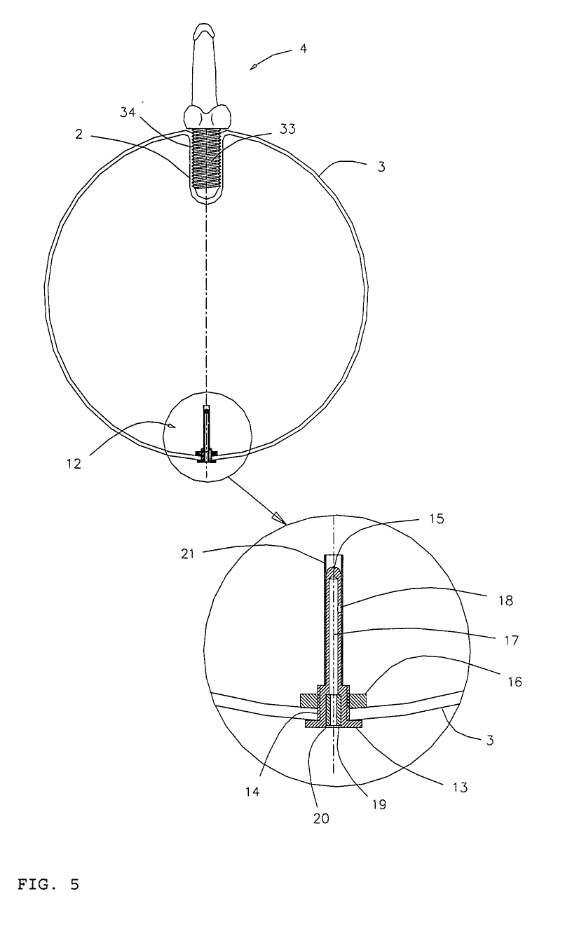

Referring to FIG. 3, a non-powered massage actuator 4 comprises a cylinder 33 having screw thread 34 for securement of the actuator to the ball is shown detached from ball 3. Referring to FIG. 4, tube 2 of the apparatus is shown inwardly reversed into ball 3, forming a cavity, and by rotating screw thread 34 of cylinder 33 into the cavity, massage actuator 4 is then held at place on the surface of ball 3. More specifically, referring to FIG. 5, a cross-sectional view with an enlarged cross-section portion, at a point on the surface of ball 3, tube 2 is inwardly reversed into ball 3 forming a cavity, and by rotating screw thread 34 of cylinder 33 into the cavity, massage actuator 4 is fixed onto the ball.

Referring still to FIG. 5 and its enlarged section, opposite point on the surface of ball 3 there is an air-nozzle 12 fixed across a portion of the surface of the ball for inflation/deflation. A needle pin 13 of the air-nozzle comprises a step-cylinder having an external screw thread 14, a hollow tube 15 having a center hole 17, an orifice 18 on the tube 15, and an opening step hole 19 for fixing a sealing tube 20 made of resilient material. A securing screw nut 16 with internal screw thread engaged with external screw thread 14 allows locating the air-nozzle 12 on the surface of the ball 3. When nut 16 is secured together with the skin of inflatable ball 3 pushed against needle pin 13 by tightening up the screw threads, an air-tight seal is established at the connection between the air-nozzle and the ball.

Again referring to FIG. 5, on the outer surface of tube 15 there is an elastic tube 21 made of resilient material tightly attached to the tube. This elastic tube 21 acts as a check valve for allowing air to be pumped into the ball. Loosening nut 16 relative to screw thread 14 will release the air trapped inside the ball.

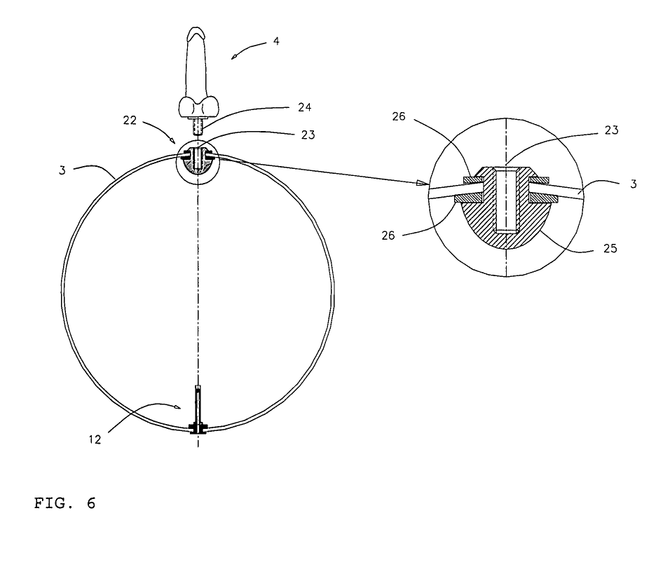

Referring now to FIG. 6, an actuator adaptor 22 fixed on the surface of ball 3 comprises a holding block 25 having an adapting hole 23 with an internal thread for engaging with connecting block 24 having an external screw thread of massage actuator 4. Washers 26 enhance the connecting rigidity of adaptor 22.

In massage application, different massage actuators can have a standardized block 24, as shown, for engaging the adapting hole, allowing the different massage actuators to be mounted to the ball.

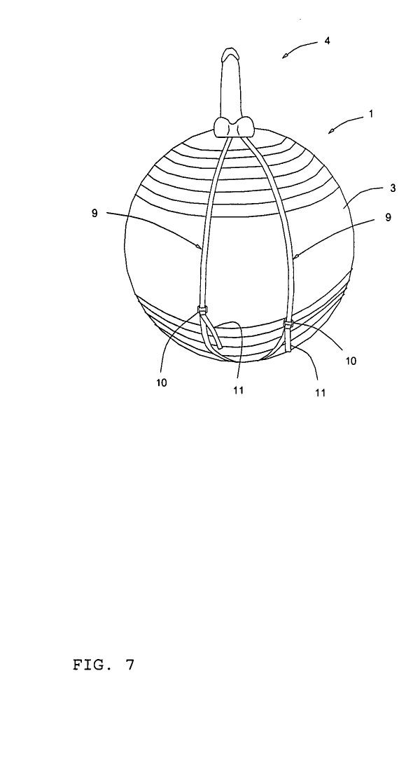

Referring to FIG. 7, another embodiment is shown. Massage actuator 4 is detachably fixed on such a suitable adaptor (not visible) attached to the surface of the ball, while the adaptor is located on the ball surface by a plurality of fastening loops disposed at different points across the center of the ball formed by ribbons (straps) 9. On the ribbon of each fastening loop, there will be seen to be a locking ring 10 and a tightening strap 11 forming a tightening mechanism.

From the foregoing, it will be seen that inflatable ball 3 of the new apparatus readily allows attachment and disattachment of either a powered actuator or a non-powered actuator and facilitates the selective orientation and fixation of any such actuator to the convenience and massage use by the user of the apparatus.

In view of the foregoing description of the present invention and various possible embodiments and methodology it will be seen that the several objects of the invention are achieved and other advantages are attained.

As various modifications could be made in the constructions and methods herein described and illustrated without departing from the scope of the invention, it is intended that all matter contained in the foregoing description or shown in the accompanying drawings shall be interpreted as illustrative rather than limiting.

What is claimed is:

1. Massage apparatus of the invention comprising:
a spherical inflatable body made of resilient material;
the body having a socket mechanism accessible at its surface for holding a massage actuator,
a massage actuator,
the body having an air-nozzle for inflation/deflation.

2. Massage apparatus according to claim 1 wherein the massage actuator is either of powered nature or non-powered nature.

3. Massage apparatus according to claim 1 wherein the massage actuator is of a phallic-simulative character.

4. Massage apparatus according to claim 1 wherein the inflatable body and massage actuator have relative position such that a user may ride on or may otherwise engage the inflatable body with the massage actuator touching or inserted into an user organ for massage.

5. Massage apparatus according to claim 1 wherein the massage actuator is detachably connected to the inflatable body.

6. Massage apparatus according to claim 5 wherein the massage actuator is carried by an actuator adaptor affixed to the ball.

7. Massage apparatus according to claim 6 wherein the actuator adaptor is a holding block providing an adapting hole internally threaded for engaging a threaded extension of a connecting block of the massage actuator.

8. Massage apparatus according to claim 6 wherein the ball is provided with a hollow tubular neck inwardly reversed into the ball as to form a cavity opening from the ball surface.

9. Massage apparatus according to claim 6 wherein the tubular neck as inwardly reversed into the ball forms a threaded cavity opening from the ball surface, the massage actuator having a threaded extension which is threaded into the cavity for securement.

10. Massage apparatus according to claim 5 wherein the massage actuator is carried by an actuator adaptor affixed to the ball, the actuator adaptor defining a holding block having an adapting hole with an internal thread for engaging a connecting block external screw thread of the massage actuator.

11. Massage apparatus according to claim 5 wherein the massage actuator is carried by an actuator adaptor attached to the surface of the inflatable ball, the adaptor being located on the ball surface by a plurality of fastening loops disposed at different points across the center of the ball, the fastening loops being formed by straps.

12. Massage apparatus according to claim 11 wherein, for the straps forming each fastening loop, there are corresponding locking rings and tightening straps, and so forming a tightening mechanism.

13. Massage apparatus according to claim 1 wherein the massage actuator is of powered nature, and further comprising a controller for controlling operation of the massage actuator.

14. Massage apparatus according to claim 13 wherein the controller for controlling the massage actuator can remotely control the massage actuator wirelessly.

15. Massage apparatus according to claim 14 wherein the controller for controlling the massage actuator can also remotely control the massage actuator wirelessly by radio frequency signals, infrared signals or provide other wireless control signals.

16. Massage apparatus according to claim 13 wherein the massage actuator comprises a squirming head, a vibration head, and a controller for controlling operation of said heads.

17. Massage apparatus according to claim 1 wherein the ball is provided with air-nozzle assembly fixed across a portion of the surface of the ball for inflation/deflation, the air nozzle assembly comprising a needle pin which includes a step-cylinder having an external screw thread, a hollow tube having a center hole, an orifice on the hollow tube, and an opening step hole for fixing a sealing tube made of resilient material, and further including a securing a nut with internal screw thread engaged with an external screw thread for locating the air-nozzle assembly on the surface of the ball, such that when the nut is secured together with skin of the inflatable ball pushed against the needle pin by tightening up the screw threads, an air-tight seal is established at the connection between the air-nozzle and the ball.

18. Massage apparatus of the invention comprising:
an inflatable rounded ball body made of elastic resilient material in the form of a ball;
the body having a socket mechanism accessible at its surface for selective holding a massage actuator of powered nature or non-powered nature in attachable and detachable manner.
the ball body having an air-nozzle for inflation/deflation.

19. Massage apparatus according to claim 18 wherein the ball body is provided with a hollow tubular neck inwardly reversed into the ball body when inflated as to form a cavity opening from an outer surface of the ball body.

20. Massage apparatus according to claim 19 wherein the tubular neck as inwardly reversed into the ball body forms a threaded cavity opening from the ball surface, the to receive a corresponding threaded extension of a massage activator for being threaded into the cavity for securement to provide the massage actuator exteriorly of the ball body and resiliently supported thereby for user access.
